(19) United States
(12) Patent Application Publication
(10) Pub. No.: US 2019/0023195 A1
(43) Pub. Date: Jan. 24, 2019

(54) Backlit Bodywork Element

(71) Applicant: Compagnie Plastic Omnium, Lyon (FR)

(72) Inventor: Issam Khayat, Lyon (FR)

(73) Assignee: Compagnie Plastic Omnium, Lyon (FR)

(21) Appl. No.: 16/067,476

(22) PCT Filed: Dec. 19, 2016
(86) PCT No.: PCT/FR2016/053554

§ 371 Date: Jun. 29, 2018

(30) Foreign Application Priority Data
Dec. 30, 2015 (FR) 1563450

(51) Int. Cl. B60R 13/04; B60Q 1/26; B60Q 3/217; B60Q 3/64; B60R 13/00; F21V 8/00; G02B 6/30; G09F 13/04

(52) U.S. Cl. CPC B60R 13/04; B60Q 1/26; B60Q 3/217; B60Q 3/64; G02B 6/04; G02B 6/001; G02B 6/305; G09F 13/04; B60Q 2500/10; B60R 13/005

(57) ABSTRACT

A motor vehicle bodywork element including a support integrated into the bodywork of the vehicle, and a plurality of optical fibres of a given length, a first end of which rests on the side of the support oriented towards the exterior of the vehicle, the part of the optical fibres resting on the support being optically diffusing, and the optical fibres are connected by a second end to a remote light source, wherein that the optical fibres are organised into a strand over all or part of the length of same.

### FIELD OF THE INVENTION

The subject of the invention is a bodywork element for a motor vehicle and more particularly a styling part intended to contribute to the exterior general appearance of the vehicle.

### BACKGROUND OF THE INVENTION

The purpose of these styling parts or bodywork elements is to emphasize a line or highlight a shape with the aim of reinforcing the image that the manufacturer desires to associated with its brand or with its vehicle model.

By way of example, the chrome strips that run along the sides of the vehicle, the protectors of body sills, the logo of the brand, the trims of door handles, and the wing-mirror covers are all styling parts the design of which is subject to particular care and attention on the part of the designers of the vehicle. By extension, all the parts of the bodywork that may be seen from the exterior and that participate in the general appearance of the vehicle, such as a door, a bumper, a grille, etc. may also be considered to be bodywork elements or styling parts that fall within the scope of application of the invention.

With the aim of reinforcing the effect produced by these bodywork elements, it has been proposed to place a light source behind the surface of the bodywork element, which is formed from a transparent material, and to modify the transparency of the coating covering the bodywork element so as to make a luminous effect appear when the external lighting conditions are insufficient and the light source is activated.

Thus, when the vehicle is illuminated by daylight, the optical device is turned off, and the appearance of the bodywork element is given by the coat of paint forming the external layer of the bodywork element. When the lighting conditions decrease, the bodywork element appears in the form of a uniformly luminous area.

By activating the lighting device, it is also possible to make particular patterns appear such as a logo specific to the brand of the manufacturer, or even particular figurative elements that remain invisible when the vehicle is illuminated by daylight.

Thus, the publication U.S. Pat. No. 5,249,104 describes a luminous device comprising: light sources that are placed in cavities formed in a diffusing body the bottom of which is equipped with a reflective surface; a top plate formed from a material that disperses light, which plate is surmounted by a semi-reflective mirror; and a transparent body the external portion of which is covered with a nonuniform opaque coating that lets a pattern appear when the luminous device is activated. The semi-reflective mirror allows the internal portion of the device to be masked from sight when the part is exposed to daylight.

Publication FR 2 840 269 describes a styling part (which bears a logo or a monogram) composed of a transparent material, behind which part are placed one or more light sources, and the external surface of which part includes a semi-reflective coating that lets light pass only in a single direction.

These luminous bodywork elements however have the drawback of including light sources that are placed directly in the portion behind the surface forming the skin of the bodywork element. The light sources are thus exposed to shocks and to the external climatic conditions experienced by the actual bodywork element. It is thus necessary to make provision for a suitable encapsulation, so as to ensure the light source is protected, and for a particular optical device for distributing the light uniformly to the external surface of the bodywork element.

As is known, it has been proposed to use optical fibers to convey light from a remotely located source. Optical fibers have the advantage of having a certain flexibility, allowing the fibers to be run along longer preset paths far more reliably than a light guide molded in a rigid and brittle material.

However, it has been observed that when the path imposed on the fibers includes changes in direction having a small radius of curvature, the optical fibers experience flexural stresses that may even cause them to break.

These changes in direction are mainly observed in the path followed by the fibers to take them from the light source to the object or site to be illuminated, but also in the visible portion when the optical fibers are configured to form a particular graphical pattern.

### SUMMARY OF THE INVENTION

The purpose of the invention is to remove the aforementioned drawbacks.

The bodywork element according to the invention comprises a holder that is integrated into the bodywork of the vehicle, and a plurality of optical fibers of given length, a first end of which rests on the side of the holder that is oriented toward the exterior of the vehicle, the portion of the optical fibers resting on the holder being diffusing so that the light radiates in a direction that is substantially perpendicular to the axis of the optical fiber, and wherein the optical fibers are connected, via a second end, to a light source. This bodywork element is characterized in that the optical fibers are organized into a braid over all or some of their length.

The organization of the fibers into a braid, in which the fibers are wound helically around the axis of the braid, forming a cable, permits the fibers to move axially with respect to one another when the cable curves to follow the path that is imposed thereon. By adjusting the number of turns per meter made by the fibers around the axis of the braid, the cable is permitted to flex to a greater or lesser extent.

Thus, it becomes easy to locate the light source, and the electrical connecting elements that accompany it, remotely in a portion of the bodywork that is sheltered from external aggressions

By optical fiber or light guide, what is meant here is a translucent or transparent elongate fiber having a higher refractive index than ambient air, in the interior of which fiber light rays travel controllably in a common axial general direction from a first end of the fiber including an entrance surface, in proximity to which one or more light sources are placed, to an exit surface from which the light rays emerge. The light propagates in the interior of the light guide by successive internal reflections of the light rays from internal faces of the fiber, which faces are called internal reflection faces. The exit surface may be formed by the face or section opposite to the entrance face, or alternatively by a lateral face of the light guide.

In the present description, and as is known to those skilled in the art, by diffusing fiber what is meant is an optical fiber in which the exit surface of the light is formed by the radial surface of the fiber. This surface, which occupies all or some of the surface of the fiber, is substantially parallel to the general direction of progression of the light in the fiber. Thus, for an optical fiber, the light emerges in a direction that is substantially radial and perpendicular to the axis of the fiber. A diffusing optical fiber therefore allows a light flux to be distributed that is substantially constant at every point on the exit surface of the diffusing portion.

The production of a diffusing optical fiber may call upon various technologies that are known as such. A first technique consists in treating the surface of the fiber considered to be the exit surface so as to make it rough. The asperities of the roughness then form as many reflective surfaces, allowing some of the light to escape from the light guide to the exterior. This technology is not very expensive, and proves to be very effective for diffusing light guides of small length, in practice for lengths smaller than 3 m. It also allows only that portion alone of the fiber which serves to provide illumination to be made diffusing. Another technology consists in doping the material forming the fiber using reflective particles of microscopic size. This technology allows the diffusion of the light to be made more uniform.

The bodywork element according to the invention also comprises, alone or in combination, the following features:
The optical fibers are arranged in a ribbon in the portion of the optical fibers resting on the holder, and the optical fibers are arranged in a braid in the segment of the fibers that is comprised between the light source and the portion resting on the holder.
The optical fibers of the portion forming the ribbon form the warp threads of a woven element.
The ribbon of optical fibers resting on the holder is intermediate between said holder and a body formed from a transparent plastic.
The body is covered on one of its faces with a semitransparent decoration consisting of:
   a translucent paint of a total thickness smaller than 20 microns or,
   a metal deposit of a thickness smaller than 200 nanometers, and preferably smaller than 100 nanometers, and even more preferably smaller than 75 nanometers or,
   a thermoformed translucent film deposited by over molding of a thickness comprised between 175 microns and 475 microns.
A layer of opaque material that does not let the light pass and that forms a pattern is interposed between the internal face of the body of the bodywork element and the ribbon of fibers resting on the holder.
The optical fibers are arranged in a braid over the entirety of their length.
In the portion of the optical fibers resting on the holder, the optical-fiber braid is surrounded by a cladding formed from a transparent plastic.
In the segment of optical fibers that is comprised between the light source and the holder, the braid of optical fibers is surrounded by a cladding that does not let the light pass.
In the segment of the optical fibers that is comprised between the light source and the holder, the optical fibers are not diffusing.
The optical fibers have a diameter comprised between 250 and 500 microns.
The fibers forming the braid are wound helically around the axis of the braid and make a number of turns per meter comprised between 10 and 100.
The light source is located remotely with respect to the holder, on an internal side of the bodywork in a zone that is sheltered from external aggressions.
The light source comprises light-emitting diodes.

### BRIEF DESCRIPTION OF THE DRAWINGS

The invention will be better understood in light of the figures, which serve to support the present description, and in which:

FIG. 1 is a view of optical fibers organized into a braid.

FIG. 2 is a perspective view of a first embodiment of the invention.

FIG. 3 shows, seen from above, the various parts forming the visible portion of a bodywork element comprising optical fibers organized into a ribbon.

FIG. 4 shows the bodywork element when the luminous device is not activated.

FIG. 5 shows the bodywork element when the luminous device is turned on.

FIG. 6 is a cross-sectional view of a bodywork element according to the invention.

FIG. 7 is a cross-sectional view of a variant embodiment in which the bodywork element comprises a decorative coating, and a pattern that may be seen when the bodywork element is turned on.

FIG. 8 is a cross-sectional view of a bodywork element in which the decorative coating is covered with a transparent protective coating.

FIG. 9 is a cross-sectional view of a bodywork element in which the decorative coating is placed on the internal face of the body.

FIG. 10 shows, seen from above, the various parts forming the visible portion of a bodywork element comprising optical fibers forming a braid.

FIG. 11 is a cross-sectional view of the braid in the portion 50 resting on the holder 3.

FIG. 12 shows the bodywork element when the luminous device is not activated.

FIG. 13 shows the bodywork element when the luminous device is turned on.

### DETAILED DESCRIPTION OF THE INVENTION

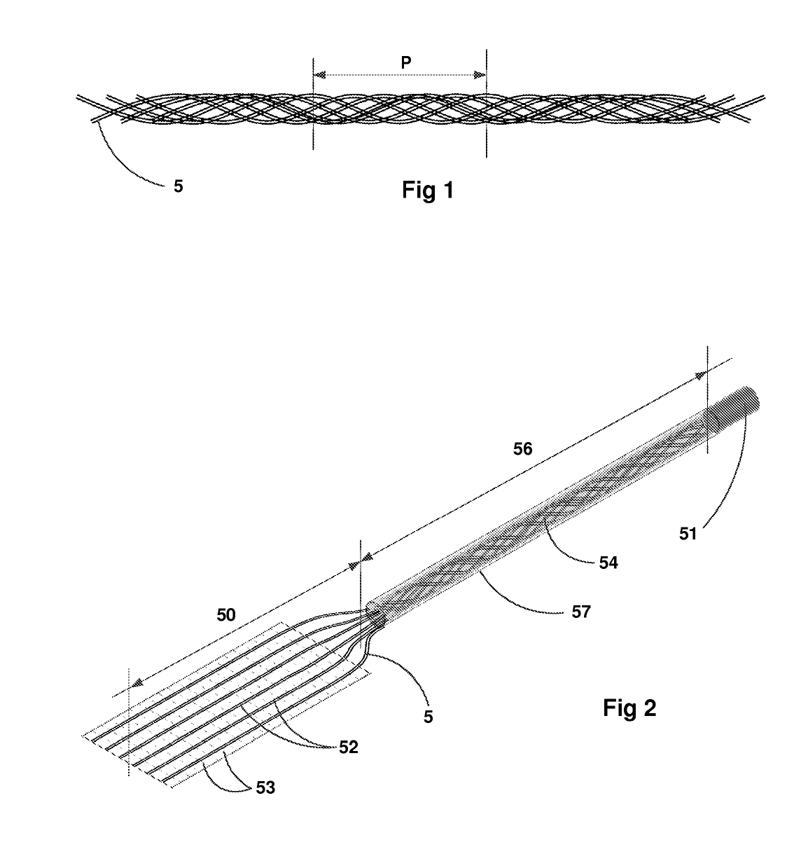

FIG. 1 shows a plurality of optical fibers 5 that are organized into a braid. The optical fibers 5 have a diameter comprised between 250 and 500 microns. They are wound around the axis of the braid helically and make a certain number of turns per unit length P around this axis. In the present case, the fibers make about 10 to 100 turns per meter. This number of turns is adjusted experimentally depending on the diameter of the fibers, the number of fibers making up the braid, and depending on the radii of curvature observed on the path followed by the braid.

FIG. 2 allows a first example of an embodiment of the invention to be illustrated, in which embodiment, at a first end 50, the optical fibers 5 are organized into a ribbon 52. This portion 50 is the portion of the fibers that is intended to serve as illuminating zone. A light source 51 is placed at a second end distant from the first. The segment 56 of the fibers that is comprised between the light source 51 and the portion 50 that is organized into a ribbon, takes the form of a braid 54 that is encapsulated in a cladding 57, which is preferably opaque.

The light source 51 is preferably formed by one or more light-emitting diodes, emitting white or colored light.

The portion 50 of the fibers 5 that is organized into a ribbon 52 is treated, as was indicated above, in order to be able to diffuse light in a direction substantially perpendicular to the axial direction, and preferably perpendicular to the plane formed by the ribbon.

At this first end 50, the fibers 5 of the ribbon 52 may form a woven element, in which the fibers 5 form the warp threads, which are retained by preferably translucent weft threads 53.

The total length of the fibers 5 is adjusted so as to continuously cover the path taken from the light source 51 to the end of the portion 50 forming the illuminated zone.

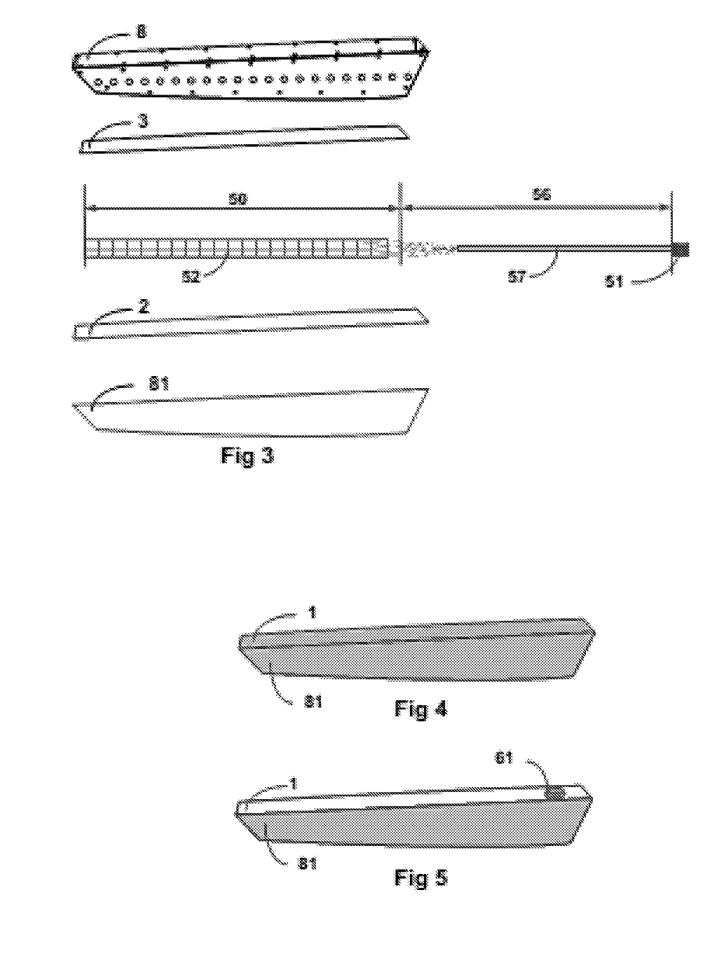

The bodywork element 1, the various parts of which are illustrated as seen from above in FIG. 3, comprises a holder 3 that is fastened to a structural part 8.

The holder 3 is preferably produced using an opaque material such as a filled polypropylene, such as that which is commonly used in the automotive industry to produce doors or parts added to the bodywork such as wing-mirror covers. The holder 3 may also be the structural part 8 into which the bodywork element is integrated.

The portion of the end 50 of the fibers that is organized into a ribbon 52, rests on the surface of the holder 3, on the side exposed to the exterior of the vehicle.

For the sake of protection, the fiber ribbon 52 may be covered by a body 2 that is transparent to light.

The body 2 is formed using an amorphous material, such as, by way of example and not exclusively, polycarbonate (PC), polymethyl methacrylate (PMMA), translucent acrylonitrile butadiene styrene (ABS) or even acrylonitrile styrene acrylate (ASA), styrene acrylonitrile (SAN), a blend of acrylonitrile styrene acrylate and polycarbonate, a blend of polycarbonate and polyethylene terephthalate.

The parts produced using these thermoplastic materials may be obtained by molding or injection molding. The shape of the body is then changed at will to blend with the shape of the bodywork on which, or around which, the bodywork element 1 is placed. The thickness of the body 2 is not limited, and is determined depending on the shape and rigidity of the bodywork element 1 that it is desired to produce; it may therefore vary from a few millimeters to one, or even two, centimeters.

The body 2 is fastened by means (not shown) to the holder 3.

The bodywork element 1 is here used to emphasize the line of a door bottom. The holder 3 is fastened to a structural part of the bodywork 8. The portion 50 of the optical fibers that is organized into a ribbon 52 is intermediate between the holder 3 and the body 2. A decorative panel 81 complements the bottom portion of the door bottom.

FIG. 4 illustrates the case in which the bodywork element 1 is illuminated by external light, such as daylight, alone.

The whole of the door bottom has, seen from the exterior, a uniform hue.

When the lighting conditions deteriorate, the light source 51 is activated, and the bodywork element appears as an area that is uniformly illuminated as is illustrated in FIG. 5. Because of the origin of the light rays, the bodywork element 1 has a backlit appearance. A pattern 61 also appears.

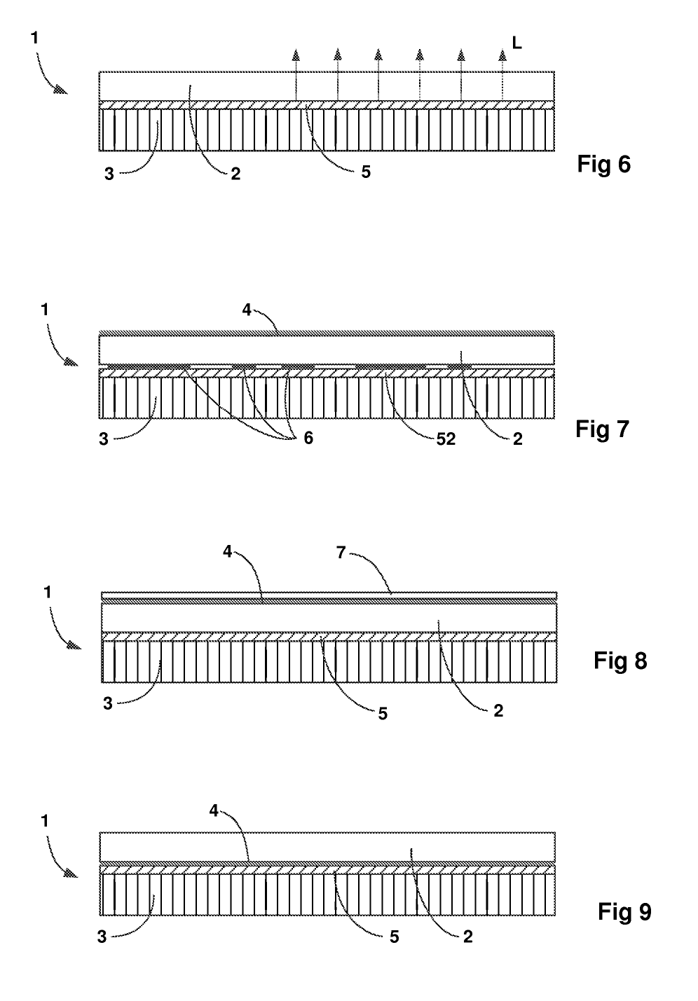

FIG. 6 allows the respective positions of the elements shown in FIG. 3 and comprising, in the direction running from the interior to the exterior of the vehicle, the holder 3, the optical fibers 5 that are organized into a ribbon that diffuses the light rays L, and the body 2, to be seen.

FIGS. 6 to 10 illustrate particular variants of this first embodiment of the invention.

FIG. 7 illustrates the case in which it is sought to make a particular pattern 61 appear when the luminous device 51 is activated. To this end, a layer of opaque material 6 that does not let light pass is deposited on the internal face of the body 2. This layer of opaque material 6 filters the light originating from the ribbon 52 in which the fibers are diffusing and lets a graphical pattern 61 such as a logo or a monogram appear.

The layer of opaque material 6 may be a coat of opaque paint in which the pattern is obtained by laser etching, or even a part that is adhesively bonded directly to the internal face of the body 2.

Alternatively, it is also possible to produce this pattern 61 at the same time as the body is manufactured, by bi-injection molding of an insert made of opaque material of the same nature as the material used for the body.

The holder 3 includes, on its external face, i.e. on the face of the body 2 facing the exterior of the vehicle and visible from the exterior, a semitransparent decorative coating 4.

The decorative coating 4 has an aesthetic first function, i.e. to provide the bodywork element 1 with a hue, so that the external surface of this element blends with the adjacent bodywork parts. The color chosen may be identical to the color of the bodywork parts, or of different color, if it is desired to emphasize a line or a particular profile.

The second function of the decorative coating 4 is to let pass all or some of the light emitted by the ribbon of fibers. It is therefore important to choose a coating of small thickness.

A plurality of technologies may be used to provide this functionality. Provision will thus possibly be made to use a translucent paint, a metal deposit or even a thermoformed translucent film.

To obtain the desired effect, the paint will preferably include a primer layer the thickness of which is comprised between 5 and 10 microns, a tinted base layer the thickness of which is comprised between 2 and 3 microns and a layer of transparent protective varnish, which is advantageously a gloss or satin varnish, the thickness of which is comprised between 5 and 10 microns. The total thickness of the paint must not exceed 20 microns.

It will also be possible to cover the body 2 of the bodywork element with a metal deposit obtained, by way of example, using a physical-vapor-deposition technique, and the thickness of which is, depending on the employed metal, smaller than 200 nanometers, and preferably smaller than 100 nanometers, and even more preferably smaller than 75 nanometers. The chosen material may, depending on the desired effect, be chromium, nickel, gold, silver, or aluminum.

Another technique consists in over molding a translucent colored film of a thickness comprised between 175 microns and 475 microns onto the external face of the body 2.

A third function of the decorative coating 4 is to redirect, as much as is possible, the incident light originating from exterior natural lighting so as to mask from sight the internal components of the bodywork element 1 such as the ribbon 52 of fibers, the logo or monogram, or even the holder 3. To this end, coatings of the metallized or glossy type, which have the effect of playing the role of a semi-transparent mirror, will preferably be chosen.

Because the decorative coating 4 is highly susceptible to scratches, in particular when this decorative coating 4 is a coat of paint or a metal coating, it is possible to deposit a protective coating 7 on the decorative layer 4 as is illustrated in FIG. 8. This protective coating 7 may usefully be produced, as is known, using a transparent thermoplastic film.

The variant embodiment illustrated in FIG. 9 shows the case in which the decorative coating 4 is placed on the internal face of the holder 2, i.e. on the face that is oriented towards the internal portion of the vehicle. This arrangement allows the protection of the decorative coating to be increased. It however limits the aforementioned semi-reflective-mirror effect. It also allows the decoration to be endowed with a particular depth effect, which effect may be amplified by adjusting the transparency or pigmentation of the material used to produce the holder.

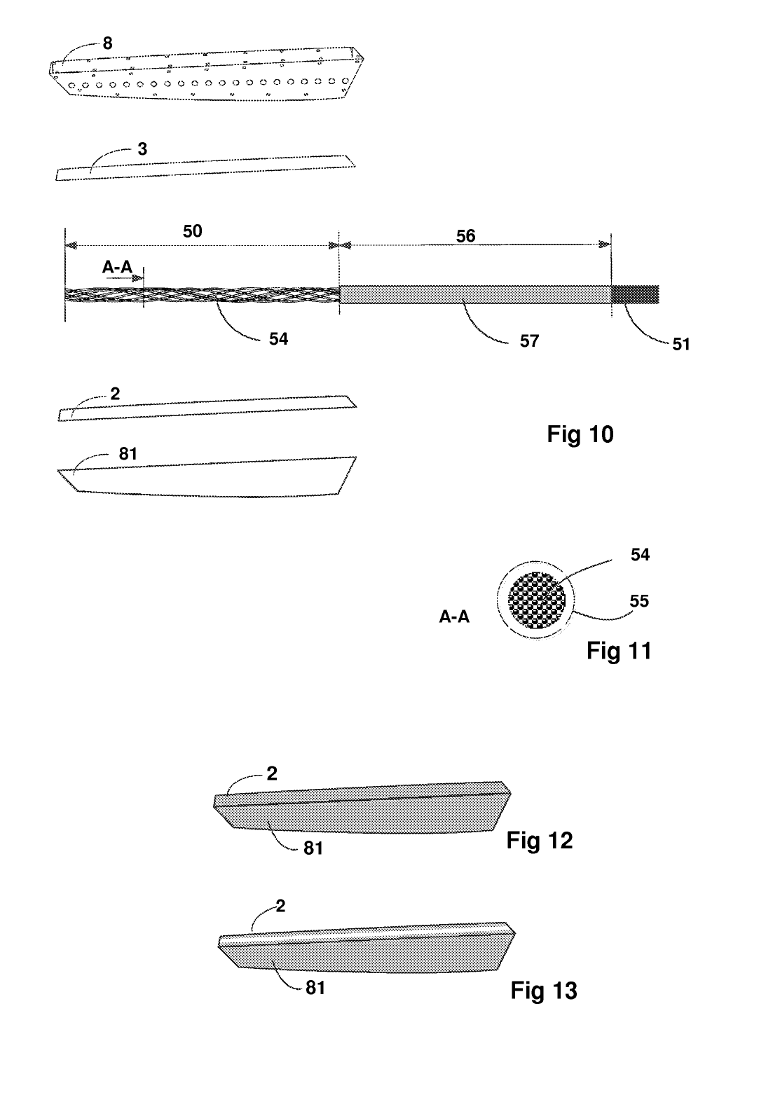

FIG. 10 allows the various portions forming the bodywork element 1 in a second embodiment of the invention to be seen.

This embodiment differs from the preceding in that, in the portion 50 of the fibers that rests on the holder 3, the fibers are organized into a braid 54. The optical fibers are therefore arranged in a braid over their entire length, from the end of the portion 50 to the light source 51.

In the portion 50, the fibers are treated in order to allow the light to diffuse in a direction that is substantially perpendicular to the axis of the fibers.

The fiber segment 56 running between the light source 51 and the portion 50 resting on the holder 3 is enclosed in an opaque cladding 57.

Similarly to the first embodiment, the fibers may be covered, in the visible portion 50, with a transparent body 2.

As a variant, it is also possible, in this portion 50, to enclose the braid 54 of fibers in a cladding 55 made of transparent thermoplastic allowing the fibers to be retained and isolated from exterior aggressions as is illustrated in FIG. 11, which is a cross-sectional view cut along AA of the braid of fibers in the portion 50.

The braid surrounded by its protective cladding 55 is heated beforehand so as to permit the shaping required to obtain the sought-after graphic. Once this shape has been achieved, the obtained pattern is set by letting the thermoplastic 55 surrounding the braid 54 cool.

FIG. 12 shows the bodywork element formed by assembling the parts of FIG. 10 illuminated by daylight. Its appearance is identical to that shown in FIG. 4. FIG. 13 allows the luminous effect, here taking the form of a line of light, produced by the same bodywork element when the light source 51 is activated, to be seen.

In the above two embodiments of the invention, and because of its flexibility, the fiber braid of the segment 50 may easily be run to a region of the bodywork that is protected from external aggressions and that is remotely located with respect to the bodywork element 1 itself, and where the light source 51 and the electrical connections are found. Preferably, the fibers are not diffusing in this segment 50.

In light of the above, those skilled in the art will be able to adapt the teachings drawn from the present description to produce bodywork elements with various functions and sizes, while providing these assemblies with the resistance and protection required by the severe demands of use of a motor vehicle.

### NOMENCLATURE

1 Bodywork element.
2 Body.
3 Holder.
4 Semitransparent decorative coating.
5 Optical fibers.
50 First end of the fibers resting on the holder 3.
51 Light source placed beside the second end of the fiber.
52 Portions of the optical fibers arranged in a ribbon.
53 Weft threads.
54 Optical fibers arranged into a braid.
55 Transparent cladding.
56 Segment of the fibers placed between the light source and the portion of the fibers resting on the holder.
57 Opaque cladding.
6 Opaque material forming a pattern.
61 Pattern.
7 Protective coating.
8 Structural part of the bodywork.
81 Panel.

1. A motor-vehicle bodywork element comprising a holder integrated into the bodywork of the vehicle, and a plurality of optical fibers of given length, a first end of the plurality of optical fibers rest on a side of the holder that is oriented toward an exterior of the vehicle, the first end of the optical fibers resting on the holder being diffusing so that light radiates in a direction that is substantially perpendicular to an axis of the optical fibers, and wherein the optical fibers are connected, via a second end, to a light source that is remotely located wherein the optical fibers are organized into a braid over all or some of their length.

2. The bodywork element according to claim 1, wherein the optical fibers are arranged in a ribbon in the first end of the optical fibers resting on the holder, and wherein the optical fibers are arranged in a braid in a segment of the fibers that is comprised between the light source and the first end resting on the holder.

3. The bodywork element according to claim 2, wherein the optical fibers of a portion forming the ribbon form warp threads of a woven element.

4. The bodywork element according to claim 2, wherein the ribbon of optical fibers is intermediate between said holder and a body formed from a transparent plastic.

5. The bodywork element according to claim 4, wherein the body is covered on one of its faces with a semitransparent decoration selected from the group consisting of:
a translucent paint of a total thickness smaller than 20 microns,
a metal deposit of a thickness smaller than 200 nanometers, and preferably smaller than 100 nanometers, and even more preferably smaller than 75 nanometers, and
a thermoformed translucent film deposited by over molding of a thickness comprised between 175 microns and 475 microns.

6. The bodywork element according to claim 4, wherein a layer of opaque material that does not let light pass and that forms a pattern is interposed between an internal face of the body of the bodywork element and the ribbon of optical fibers resting on the holder.

7. The bodywork element according to claim 1, wherein the optical fibers are arranged in a braid over an entirety of their length.

8. The bodywork element according to claim 7, wherein, in the first end, the optical-fiber braid is surrounded by a cladding formed from a transparent plastic.

9. The bodywork element according to claim 1, wherein, in a segment of optical fibers that is comprised between the light source and the holder, the braid of optical fibers is surrounded by a cladding that does not let light pass.

10. The bodywork element according to claim 1, wherein, in a segment of the optical fibers that is comprised between the light source and the holder, the optical fibers are not diffusing.

11. The bodywork element according to claim 1, wherein the optical fibers have a diameter comprised between 250 and 500 microns.

12. The bodywork element according to claim 1, wherein the optical fibers forming the braid are wound helically around the axis of the braid and make a number of turns per meter comprised between 10 and 100.

13. The bodywork element according to claim 1, wherein the light source is located remotely with respect to the holder, and on an internal side of the bodywork in a zone that is sheltered from external aggressions.

14. The bodywork element according to claim 6, wherein the light source comprises light-emitting diodes.
